(19) United States
(12) Patent Application Publication
(10) Pub. No.: US 2021/0294060 A1
(43) Pub. Date: Sep. 23, 2021

(54) MID-SPAN CONSOLIDATORS FOR AERIAL CABLES

(71) Applicant: AFL Telecommunications LLC, Duncan, SC (US)

(72) Inventors: Steven Kranz, Moore, SC (US); Russell Brent Sanders, Greenville, SC (US); Samuel Berry, Greer, SC (US)

(21) Appl. No.: 16/822,824

(22) Filed: Mar. 18, 2020

(51) Int. Cl. G02B 6/48; G02B 6/44

(52) U.S. Cl. CPC G02B 6/483; G02B 6/443

(57) ABSTRACT

Mid-span consolidators for consolidating aerial cables are provided. A mid-span consolidator includes an inner bushing. The inner bushing extends along a longitudinal axis between a first end and a second end and defines a length. The inner bushing further defines a plurality of slots, each of the plurality of slots extending between the first end and the second end and configured to accept one of the plurality of cables. The mid-span consolidator further includes an outer cover surrounding the inner bushing. The outer cover extends along a longitudinal axis between a first end and a second end and defines a length.

### FIELD

The present disclosure relates generally to mid-span consolidators for use with aerial cables, and more specifically to mid-span consolidators which advantageously collect and secure aerial cables together to reduce or prevent cable damage, tangling, and poor cable aesthetics.

### BACKGROUND

Optical fiber is increasingly being used for a variety of applications, including broadband applications such as voice, video and data transmissions. As a result of this increasing demand, fiber optic networks typically include a large number of mid-span access locations at which one or more optical fibers are branched from a distribution cable. These mid-span access locations provide a branch point from the distribution cable and may lead to an end user, commonly referred to as a subscriber. Fiber optic networks which provide such access are commonly referred to as FTTX “fiber to the X” networks, with X indicating a delivery point such as a home (i.e. FTTH).

Drop cables are utilized to connect the end user to the distribution cable and thus the fiber optic network. For example, multi-port optical connection terminals have been developed for interconnecting drop cables with a fiber optic distribution cable at a predetermined branch point in a fiber optic network between a mid-span access location on the distribution cable and a delivery point such as a subscriber premises. Utilizing such terminals, drop cables extending from a delivery point may be physically connected to the communications network at the branch point provided by such terminals as opposed to at the actual mid-span access location provided on the distribution cable. Alternatively, however, drop cables may connect to the distribution cable at the mid-span access location.

Cables of the fiber optic network, such as stub cables and drop cables, may extend above the ground over relatively long distances. Further, in many cases, multiple of such aerial cables can extend in parallel, such as between the same poles or other support apparatus. The use of multiple cables, while desirable for providing increased network access, can lead to undesirable results. For example, high winds and other external forces can cause the cables to contact each other, leading to cable jacket damage and tangling as well as poor cable aesthetics. Further, ice accumulation and loading on individual cables can cause significant damage to the cables.

Accordingly, improved devices for collecting and securing aerial cables, such as in communications networks, would be advantageous. In particular, improved devices which are capable of collecting and supporting multiple aerial cables and reducing or preventing cable damage, tangling, and poor cable aesthetics would be desired in the art.

### BRIEF DESCRIPTION

Aspects and advantages of the mid-span consolidators in accordance with the present disclosure will be set forth in part in the following description, or may be obvious from the description, or may be learned through practice of the technology.

In accordance with one embodiment, a mid-span consolidator for consolidating a plurality of aerial cables is provided. The mid-span consolidator includes an inner bushing. The inner bushing extends along a longitudinal axis between a first end and a second end and defines a length. The inner bushing further defines a plurality of slots, each of the plurality of slots extending between the first end and the second end and configured to accept one of the plurality of cables. The mid-span consolidator further includes an outer cover surrounding the inner bushing. The outer cover extends along a longitudinal axis between a first end and a second end and defines a length.

In some embodiments, the length of the outer cover is greater than the length of the inner bushing.

In accordance with another embodiment, a mid-span consolidator for consolidating a plurality of aerial cables is provided. The mid-span consolidator includes an inner bushing. The inner bushing extends along a longitudinal axis between a first end and a second end and defines a length. The inner bushing further defines a plurality of slots, each of the plurality of slots extending between the first end and the second end and configured to accept one of the plurality of cables. The mid-span consolidator further includes an outer helical cover surrounding the inner bushing and extending between a first end and a second end. The outer helical cover includes a first end portion which includes the first end, a second end portion which includes the second end, and a middle portion between the first end portion and the second end portion. A width of the middle portion is greater than a width of the first end portion and the second end portion.

These and other features, aspects and advantages of the present mid-span consolidators will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present mid-span consolidators, including the best mode of making and using the present systems and methods, directed to one of ordinary skill in the art, is set forth in the specification, which makes reference to the appended figures, in which:

FIG. 1 is a schematic illustration of a known fiber optic communications network;

FIG. 2 is a perspective view of a mid-span consolidator consolidating a plurality of aerial cables in accordance with embodiments of the present disclosure;

FIG. 3 is a perspective view of an inner bushing of a mid-span consolidator in accordance with embodiments of the present disclosure;

FIG. 4 is a side view of an outer cover of a mid-span consolidator in accordance with embodiments of the present disclosure; and

FIG. 5 is a cross-sectional view of a cable in accordance with embodiments of the present disclosure.

### DETAILED DESCRIPTION

Reference now will be made in detail to embodiments of the present mid-span consolidators, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component. terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

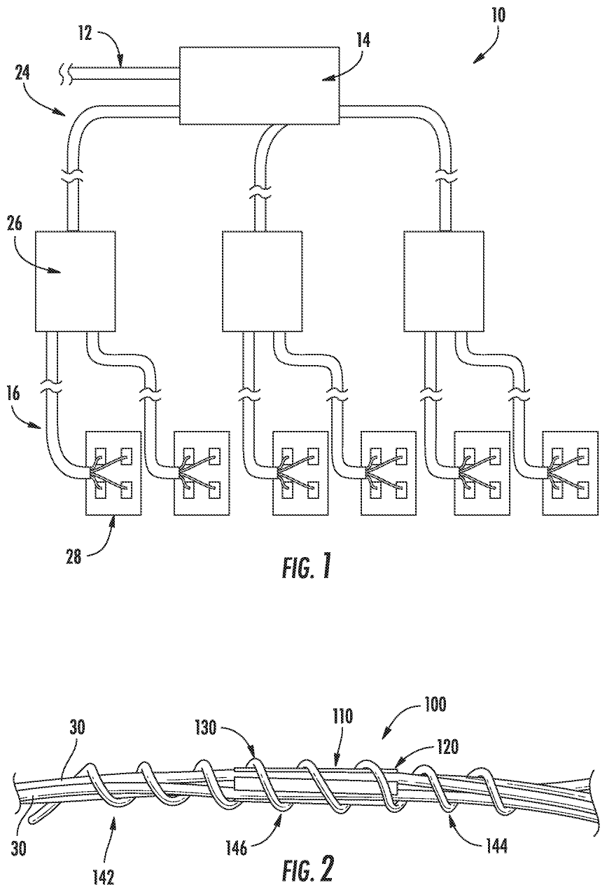

Referring now to FIG. 1, a portion of a known fiber optic communications network 10 which includes a fiber optic distribution cable 12 is shown. One or more mid-span access locations are provided along the length of the distribution cable 12. The mid-span access location may be enclosed and protected from exposure to the environment by a conventional closure 14. The fiber optic communications network 10 may include a fiber optic distribution cable 12 having a plurality of mid-span access locations at branch points spaced along the length of the distribution cable, each providing access to at least one, and preferably, a plurality of optical fibers of the fiber optic network. Thus, in the embodiments shown, the distribution cable 12 may provide multiple locations for joining stub cables 24 of multi-port optical connection terminals 26 to the distribution cable 12 at each mid-span access location.

In the fiber optic network 10 as illustrated, pre-terminated optical fibers of the distribution cable 12 provided at the mid-span access location are routed out of the distribution cable and spliced to respective optical fibers of a stub cable 24 extending from a multi-port optical connection terminal 26. The optical fibers of the stub cable 24 may enter the closure 14 through a suitable cable port provided through an exterior wall, for example an end wall, of the closure 14. The stub cable 24 includes at least one, and preferably a plurality of optical fibers disposed within a protective cable sheath. The stub cable 24 may, for example, be any known fiber optic cable which includes at least one optical fiber and having a fiber count equal to or greater than that of a drop cable 16 to be connected to the multi-port optical connection terminal 26 and equal to or less than that of the distribution cable 12.

The stub cable 24 may extend from the closure 14 into a terminal 26. The optical fibers of the stub cable 24 within the terminal 26 may be connectorized. One or more connectorized drop cables 16 may be interconnected with the connectorized optical fibers of the stub cable 24, i.e. in terminal 26. The drop cables 16 may include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a terminal 26 positioned at a distance from the mid-span access location, such as a telephone pole, hand-hole, vault or pedestal (not shown) in the fiber optic network 10. Each drop cable 16 extends from a terminal 26 to another terminal 26 or to an outside plant connection terminal 28 located at a delivery point such as a subscriber home.

It should be understood that the present disclosure is not limited to the above-described embodiment of a fiber optic network 10, and rather that any suitable fiber optic network 10 or other suitable communications network is within the scope and spirit of the present disclosure.

Referring now briefly to FIG. 5, a cable 30 in accordance with embodiments of the present disclosure is illustrated. Cable 30 may, in exemplary embodiments, be utilized as a stub cable 24 and/or drop cable 16. As shown, cable 30 may include a plurality of optical fibers 40 disposed within a buffer tube 42. In some embodiments, a gel may be provided in the buffer tube 42 surrounding the optical fibers 40. Cable 30 may further include strength members 44, which in exemplary embodiments may be water blocking dielectric strength members. A water blocking thread 46 may additionally be provided in the cable 30. A jacket 48 may surround the strength members 44, buffer tube 42 and water blocking thread 46. The jacket 48 may, for example, be formed from a UV resistant material. The jacket 48 may include and form an outermost layer and exterior surface of the cable 30. In some embodiments as shown, the 30 generally, and thus the jacket 48 thereof, may have an oval-shaped cross-sectional profile. Accordingly, the cross-sectional profile may have a major radius and a minor radius which are not equal (with the major radius being greater than the minor radius), as opposed to a circular cross-sectional profile which has a constant radius. Such cable 30 may be termed a “flat drop” cable. Alternatively, cable 30 may have a circular cross-sectional profile. It should be understood that the present disclosure is not limited to the above-disclosed flat drop or drop cable embodiments, and rather that the use of any suitable cable 30 (whether fiber optic, electric, or otherwise) is within the scope and spirit of the present disclosure.

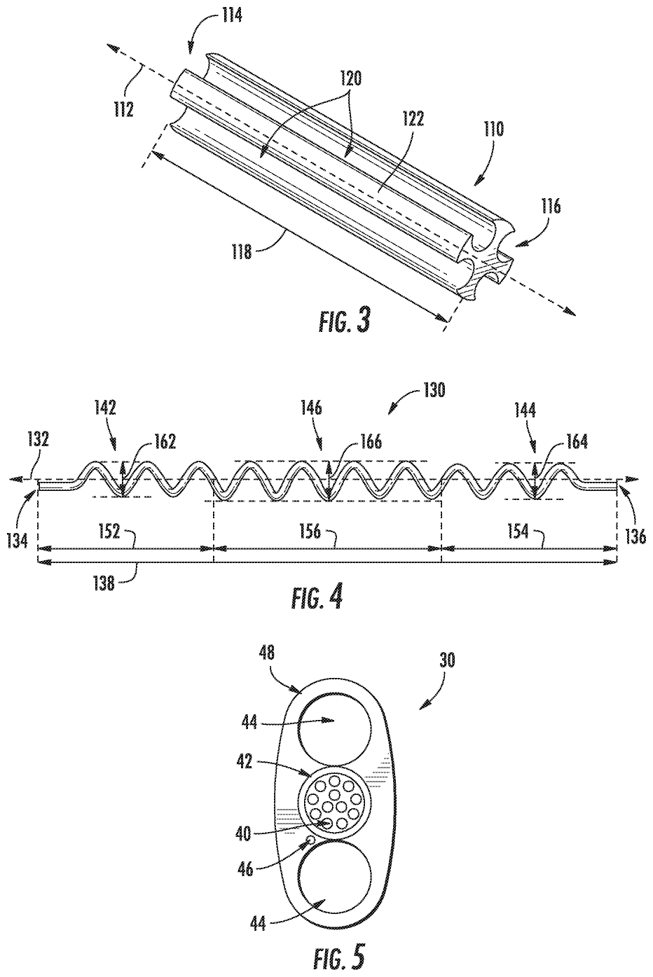

Referring now to FIGS. 2 through 4, embodiments of mid-span consolidators 100 in accordance with embodiments of the present disclosure are provided. Such mid-span consolidators 100 may advantageously collect and secure, and thus consolidate, a plurality of cables 30, such as aerial cables as discussed herein. The consolidated cables may advantageously be at reduced or eliminated risk of damage via contact with each other or tangling due to use of such mid-span consolidators 100, as the mid-span consolidators 100 may position the cables 30 in a secure manner relative to one another such that, for example, the cables 30 move together rather than independently due to high winds and other external forces. Further, use of such mid-span consolidators 100 may advantageously improve the aesthetics of the multiple aerial cables 30 by grouping such cables 30 close together in a secure manner. Still further, use of such mid-span consolidators 100 reduces the risk of ice accumulation and loading on individual cables 30, instead facilitating shared loading and ice weight distribution by multiple cables 30 and the consolidators 100 such that the damage risk is reduced.

A mid-span consolidator 100 in accordance with the present disclosure may advantageously include an inner bushing 110. Inner bushing 110 may directly secure therein the cables 30 of a plurality of cables 30 (such as aerial cables 30) being consolidated. As shown, an inner bushing 110 may extend along a longitudinal axis 112 between a first end 114 and a second end 116. A length 118, e.g. a maximum length 118 between the first end 114 and second end 116, may be defined along the longitudinal axis 112 for the inner bushing 110.

In exemplary embodiments, inner bushing 110 may have a generally circular cross-sectional shape, as illustrated. Alternatively, however, other suitable shapes may be utilized. For example, inner bushing 110 may have an oval cross-sectional shape, triangular cross-sectional shape, rectangular cross-sectional shape, or other suitable polygonal cross-sectional shape.

A plurality of slots 120 may be defined in the inner bushing 110. The plurality of slots 120 may each be configured to accept one or more of a plurality of cables 30. Each slot 120 may be an external slot 120 which is defined through an exterior surface 122 of the inner bushing 110. Further, each slot 120 may be defined in and extend through the first end 114 and second end 116. In particular, each slot 120 may extend between the first end 114 and second end 116, such as along the longitudinal axis 112.

Any suitable number of slots 120 may be included in an inner bushing 110. For example, in exemplary embodiments, three or more, such as four, slots 120 may be utilized. Further, in exemplary embodiments, the slots 120 may be equally spaced apart about a perimeter of the inner bushing 110, such as in some embodiments in an annular array.

In exemplary embodiments, the inner bushing 110 is formed from a polymer, such as an elastomer. For example, inner bushing 110 may in exemplary embodiments be formed from a synthetic rubber, such as an ethylene propylene diene monomer (“EPDM”) rubber. Alternatively, another suitable polymer for the inner bushing 110 is polyvinyl chloride (“PVC”). In still further alternative embodiments, the inner bushing 110 may be formed from a suitable non-polymer material, such as a metal (e.g. extruded aluminum). In exemplary embodiments, the inner bushing 110 is formed such that it is non-abrasive with no sharp edges to reduce the risk of cable 30 damage during use.

As discussed, each slot 120 may be configured to accept one or more of the plurality of cables 30. For example, each slot 120 may have a cross-sectional shape and size which corresponds to the shape and size of a single cable 30 or multiple cables to be inserted within the slot 120. Accordingly, when a cable 30 is inserted into the slot 120, the cable 30 may be partially or fully accommodated by the slot 120 in a generally secure manner and the risk slipping of the cable 30 from the slot 120 may be reduced or prevented. The inner bushing 110 material may further advantageously facilitate secure holding of the cables 30 in the slots 120.

Notably, the use of inner bushing 110 with multiple slots 120 advantageously allows for the consolidator 100 to be utilized with various different numbers of cables 30, and further allows for cables 30 to be added or removed as desired. Each slot 120 need not include a cable 30 for the inner bushing 110 and consolidator 100 generally to be properly installed.

A mid-span consolidator 100 in accordance with the present disclosure may advantageously further include an outer cover 130 which surrounds the inner bushing 120. Outer cover 130 may further consolidate the cables 30. For example, cables 30 accommodated in the inner bushing 110 may be further secured by the outer cover 130, as the cables 30 are positioned between the inner bushing 110 and outer cover 130. Outer cover 130 may thus further reduce or prevent slipping of the cables 30 from the slots 120. Still further, outer cover 130 may in exemplary embodiments accommodate and hold portions of the cables 30 beyond those portions held by the inner bushing 110, thus providing additional consolidation, further reducing the risk of damage and tangling, and increasing aesthetics. In exemplary embodiments, the outer cover 130 is designed such that movement relative to the inner bushing 110 is reduced or eliminated. Further, in exemplary embodiments, the outer cover 130 is designed to reduce or eliminate movement of the consolidator 100 generally relative to cables 30.

As shown, an outer cover 130 may extend along a longitudinal axis 132 (which may by fully or partially coaxial with longitudinal axis 112) between a first end 134 and a second end 136. A length 138, e.g. a maximum length 138 between the first end 134 and second end 136, may be defined along the longitudinal axis 132 for the outer cover 130.

In exemplary embodiments, the outer cover 130 may be a helical structure, and thus an outer helical cover 130. For example, the outer cover 130 may extend helically along the longitudinal axis 132 between the first end 134 and the second end 136, as shown. A helical structure for the outer cover 130 may be particularly advantageous, as it allows for removal and insertion of individual cables 30 from the outer cover 130, inner bushing 110, and mid-span consolidator 100 generally without requiring removal of the outer cover 130 from surrounding the inner bushing 110.

It should be noted that lengths of the outer cover 130 and various portions thereof in accordance with the present disclosure are measured along the longitudinal axis 132, and are not measured helically along the cover 130.

In exemplary embodiments, the length 138 of the outer cover 130 is greater than the length 118 of the inner bushing 110. Accordingly, when assembled, the first and second ends 134, 136 of the outer cover 130 extend beyond the first and second ends 114, 116 of the inner bushing 110, such as along the longitudinal axes 112, 132. Such relatively greater length advantageously provides additional consolidation as discussed above.

In exemplary embodiments, the outer cover 130 is formed from a suitable polymer, such as in particular exemplary embodiments PVC. The use of PVC in particular advantageously allows for the outer cover 130 to be flexible, such that for example easy insertion and removal of cables 30 is facilitated, while maintaining strength such that the cables 30 are advantageously consolidated as discussed herein.

In exemplary embodiments, outer cover 130 includes a first end portion 142, a second end portion 144, and a middle portion 146. First end portion 142 extend from and includes the first end 134. Second end portion 144 extends from and includes the second end 136. Middle portion 146 extends to and between first end portion 142 and second end portion 144. A length 152 and width 162 (e.g. a maximum length and width) may be defined for the first end portion 142. A length 154 and width 164 (e.g. a maximum length and width) may be defined for the second end portion 144. A length 156 and width 166 (e.g. a maximum length and width) may be defined for the middle portion 146.

In exemplary embodiments, the length 156 of the middle portion 146 is greater than or equal to the length 118 of the inner bushing 110. Additionally or alternatively, the length 156 of the middle portion 146 is greater than the length 152 of the first end portion 142 and the length 154 of the second end portion 154. Additionally or alternatively, the first end portion 142, second end portion 144, and middle portion 146 may have varying widths 162, 164, 166 relative to each other. For example, the width 166 of the middle portion 146 may be greater than the width 162 of the first end portion 142 and the width 164 of the second end portion 144. The relatively smaller first end portion 142 and second end portion 144 advantageously facilitate further consolidation of the cables 30 by maintaining portions of the cables 30 which have exited the inner bushing 110 in a secure grouping, thus further reducing the risk of damage and tangling, and increasing aesthetics.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A mid-span consolidator for consolidating a plurality of aerial cables, the mid-span consolidator comprising:
an inner bushing, the inner bushing extending along a longitudinal axis between a first end and a second end and defining a length, the inner bushing further defining a plurality of slots, each of the plurality of slots extending between the first end and the second end and configured to accept one of the plurality of cables; and
an outer helical cover surrounding the inner bushing and extending between a first end and a second end, the outer helical cover comprising a first end portion which includes the first end, a second end portion which includes the second end, and a middle portion between the first end portion and the second end portion, and wherein a width of the middle portion is greater than a width of the first end portion and the second end portion.

2. The mid-span consolidator of claim 1, wherein the plurality of slots are equally spaced apart in an annular array.

3. The mid-span consolidator of claim 1, wherein the plurality of slots is four slots.

4. The mid-span consolidator of claim 1, wherein the inner bushing is formed from an elastomer.

5. The mid-span consolidator of claim 1, wherein the inner bushing is formed from a synthetic rubber.

6. The mid-span consolidator of claim 1, wherein a length of the middle portion is greater than or equal to a length of the inner bushing.

7. The mid-span consolidator of claim 1, wherein a length of the middle portion is greater than a length of the first end portion and the second end portion.

8. The mid-span consolidator of claim 1, wherein the outer helical cover is formed from polyvinyl chloride.

9. A mid-span consolidator for consolidating a plurality of aerial cables, the mid-span consolidator comprising:
an inner bushing, the inner bushing extending along a longitudinal axis between a first end and a second end and defining a length, the inner bushing further defining a plurality of slots, each of the plurality of slots extending between the first end and the second end and configured to accept one of the plurality of cables; and
an outer cover surrounding the inner bushing, the outer cover extending along a longitudinal axis between a first end and a second end and defining a length, wherein the length of the outer cover is greater than the length of the inner bushing.

10. The mid-span consolidator of claim 9, wherein the plurality of slots are equally spaced apart in an annular array.

11. The mid-span consolidator of claim 9, wherein the plurality of slots is four slots.

12. The mid-span consolidator of claim 9, wherein the inner bushing is formed from an elastomer.

13. The mid-span consolidator of claim 9, wherein the inner bushing is formed from a synthetic rubber.

14. The mid-span consolidator of claim 9, wherein the outer cover is helical.

15. The mid-span consolidator of claim 9, wherein the outer cover comprises a first end portion which includes the first end, a second end portion which includes the second end, and a middle portion between the first end portion and the second end portion, and wherein a width of the middle portion is greater than a width of the first end portion and the second end portion.

16. The mid-span consolidator of claim 15, wherein a length of the middle portion is greater than or equal to a length of the inner bushing.

17. The mid-span consolidator of claim 15, wherein a length of the middle portion is greater than a length of the first end portion and the second end portion.

18. The mid-span consolidator of claim 9, wherein the outer helical cover is formed from polyvinyl chloride.
